(19) United States
(12) Patent Application Publication
(10) Pub. No.: US 2003/0132612 A1
(43) Pub. Date: Jul. 17, 2003

(54) Stroller with programmable information module

(75) Inventors: Robert T. Pike, West Lawn, PA (US); Dennis Stauffer, Birdsboro, PA (US)

Correspondence Address: FOLEY AND LARDNER, SUITE 500, 3000 K STREET NW, WASHINGTON, DC, 20007, US

(73) Assignee: Graco Children's Products Inc.

(21) Appl. No.: 10/376,606

(22) Filed: Mar. 3, 2003

Related U.S. Application Data
(62) Division of application No. 09/852,299, filed on May 10, 2001.
Application No. 09/852,299 is a continuation of application No. 09/851,412, filed on May 9, 2001.

(51) Int. Cl. B62B 7/00

(52) U.S. Cl. 280/642; 280/47.38

(57) ABSTRACT

The present invention provides a stroller having a programmable information module. The information module is configured to provide at least one user-programmable function. The information module communicates with a display unit to display, for example, power on, a timer start/stop control, ambient temperature, distance walked/jogged, a calorie count, a timer, a speed, or other desired information. In one embodiment, the stroller includes a collapsible frame wherein the programmable information module is attached to the handle frame and is configured to provide at least one user-programmable function. The stroller can have front right, front left, rear right, and rear left legs pivotally connected to the handle frame and a seat frame that has an intermediate bar and right and left arms that extend from the intermediate bar.

This application is a continuing application of U.S. application Ser. No. ______, filed May 9, 2001, by Pike et al. and entitled “Stroller With Programmable Information Module,” to which this application claims benefit.

### BACKGROUND

U.S. Pat. Nos. 5,454,584 and 5,605,409 issued to Haut et al. each disclose a collapsible stroller having an λ-shaped frame (hereafter “A-shaped frame”). The stroller may be in a collapsed position or may be opened to an operating position. The disclosures of these patents are incorporated herein by reference. Such a collapsible stroller includes soft goods made of fabric, such as a seat, back support, canopy, storage basket, etc., and fabric that covers parts of the stroller frame. The back support may be configured to be in a sitting position, or alternatively, in a recumbent or lying position. Regardless of where the back support is positioned, the stroller may be folded. The stroller can include a latch to automatically lock the stroller in the collapsed position to prevent the stroller from unfolding during handling, and the stroller can have hinge locks that lock the stroller in the operating position. Further, this stroller can have ergonomically correct gripping portions to allow the user to travel extended distances more comfortably.

Cosco® makes an Infant/Toddler Jogger Stroller that has all-terrain bicycle wheels that provides the advantage of wheels that are capable of maneuvering on many types of terrain. Another commercially available stroller has oversized fake-chrome wheels decorated with simulated lug nuts, a horn, a toy radio, a gearshift, a steering wheel, and four-wheel independent suspension. Scamper™ provides a stroller with a console tray with a cupholder on the stroller handle. Contura™ provides a stroller that is self-standing when folded and another stroller with a console tray that has a compartment with a cover that has a vanity mirror installed thereon. The Endeavor™ provides a stroller with a snap-off dishwasher-safe console tray with a cupholder on the stroller handle. Evenflo® produces a stroller that has a parent convenience console with a cup holder.

Although conventional strollers offer a multitude of features, these strollers can be improved to be more desirable to health-conscious parents, who want to know and to measure the time and distance spent jogging or walking fast. Also, since baby-sitters are not always easy to find and convenient to schedule, it would be advantageous to be able to combine the parent's desire to fast walk or jog with pushing the youngster on an outing.

### SUMMARY OF THE INVENTION

The present invention provides a stroller that includes a programmable information unit that can perform a number of parent-oriented programmable functions, such as measuring or estimating the number of calories being expended by the person pushing the stroller, measuring the ambient temperature, and measuring time, speed, and distance. In this regard, the programmable information unit can include a timer for desired travel or count-down time, a speed-measuring unit, an odometer, a temperature sensor, and the like. The programmable information unit can be readily accessed and utilized by a person who is pushing the stroller. For example, the programmable information unit can be attached to the handle frame of the stroller, for example, by mounting it to a parent tray connected to the handle frame, or by attaching it directly to the handle frame.

According to an aspect of the invention, a stroller includes a handle frame and a programmable information module attached to the handle frame and configured to provide at least one user-programmable function. The programmable information module is programmable and, for example, can be used to determine an approximate ambient temperature and to display the temperature on a display unit or the like, can be preset by a user to a desired value of either time or distance and then be programmable by the user to start with the desired time or desired distance and count down to a zero value, can be programmable by a user to compute a speed at which the stroller is traveling, and/or can be used to compute distance traveled, calories burned by a person pushing the stroller, or time elapsed during a period of time that the stroller is pushed.

According to another aspect of the invention, a stroller includes a handle frame and a programmable information module attached to the handle frame and configured to provide at least one user-programmable function. The stroller can have front right, front left, rear right, and rear left legs pivotally connected to the handle frame; a seat frame having right and left arms that are pivotally connected to the front and rear right legs and the front and rear left legs, respectively; and a cross brace connected to the rear right and left legs. The stroller can be movable between a collapsed position and an operating position.

According to yet another aspect of the invention, a programmable information unit for a stroller can include a device attached to the handle frame, where the device has disposed therein a programmable information module coupled to receive input from a user, and the device has a display unit, coupled to the programmable information module, for selectably displaying information for an electronic function selected by a user.

According to still another aspect of the invention, a stroller can include a collapsible frame that is movable between a collapsed position and an operating position. The collapsible frame can have a handle frame and front right, front left, rear right, and rear left legs pivotally connected to the handle frame. The stroller also can include a parent tray attached to the handle frame. The parent tray can have a programmable information module mounted thereto arranged to receive a signal from a transmitter located proximate to a wheel, where the signal represents rotation of the wheel.

According to a further aspect of the invention, a stroller frame has a handle frame and front right, front left, rear right, and rear left legs connected to the handle frame. Each of the legs terminates at a wheel. The stroller also has a parent tray attached to a handle frame and a programmable information module mounted to the parent tray. The stroller further has a wheel position recognition device associated with at least one wheel of the stroller, where the wheel position recognition device generates a signal representative of rotation of the wheel for transmission to and processing by the programmable information module.

### BRIEF DESCRIPTION OF THE DRAWINGS

These and other features, aspects, and advantages of the present invention will become more apparent from the following description, appended claims, and accompanying exemplary embodiments shown in the drawings, which are briefly described below.

FIG. 1 is a perspective view of a collapsible stroller (in the operating position) with a programmable information module in accordance with the present invention, wherein the programmable information module provides a selection of programmable functions for a person pushing the stroller.

FIG. 2 is an enlarged, perspective view of a parent tray of the collapsible stroller of FIG. 1.

FIG. 3 is a partial bottom perspective view of the parent tray of FIG. 2, illustrating a connector.

FIG. 4 is a front elevation view of the parent tray of the collapsible stroller of FIG. 1, wherein the lid of the parent tray is in an open position.

FIG. 5 is a rear perspective view of the parent tray of the collapsible stroller of FIG. 1, wherein the lid of the parent tray is in a closed position.

FIG. 6 is a top plan view of the programmable information unit of FIG. 1.

FIG. 7 is a detailed view of an LCD module in accordance with the invention, wherein five selected embodiments of the LCD module are represented.

FIG. 8 is a an exploded, schematic representation of one embodiment of the parent tray and programmable information unit of the present invention.

FIG. 9 is a top plan view of a parent tray lid in accordance with the invention.

FIG. 10 is front-to-back cross-sectional view taken along line 10-10 of FIG. 9, illustrating one embodiment of the apertures for placement of the LCD module and an operational function button as well as the placement of the LCD module on the lid of the parent tray.

FIG. 11 is a front-to-back cross-sectional view taken along line 11-11 of FIG. 9, illustrating one embodiment of the aperture for the LCD module and placement of the LCD module on the lid of the parent tray.

FIG. 12 is a side-to-side cross-sectional view taken along line 12-12 in FIG. 9, illustrating one embodiment of the apertures for the LCD module and a programming button of the programmable information unit.

FIG. 13 is a back view of a wheel assembly of a stroller with a transmitter and reed switch in accordance with the present invention.

FIG. 14 is a top view of a wheel assembly of a stroller with a transmitter and reed switch in accordance with the present invention.

FIG. 15 is a schematic representation of an LCD display with units of measurement in accordance with the present invention.

FIG. 16 is a schematic representation of one embodiment of a jogging stroller frame with a programmable information module in accordance with the present invention.

FIG. 17 is a schematic representation of another embodiment of a jogging stroller frame with a programmable information module in accordance with the present invention.

FIG. 18 is a schematic representation of a hard-wired stroller in accordance with an alternative embodiment of the invention.

FIG. 19 is a view of a programmable information unit that includes a port.

### DETAILED DESCRIPTION OF PREFERRED EMBODIMENTS

Although references are made here to directions in describing the structure, they are made relative to the drawings (as normally viewed) for convenience. The directions, such as left, right, upper, lower, inward, outward, etc., are not intended to be taken literally or to limit the present invention in any form. Moreover, the numerical nomenclatures, first, second, third, fourth, etc., are used solely for purposes of tracking the structural elements. These numerical nomenclatures are not intended to be taken literally or to limit their associated elements.

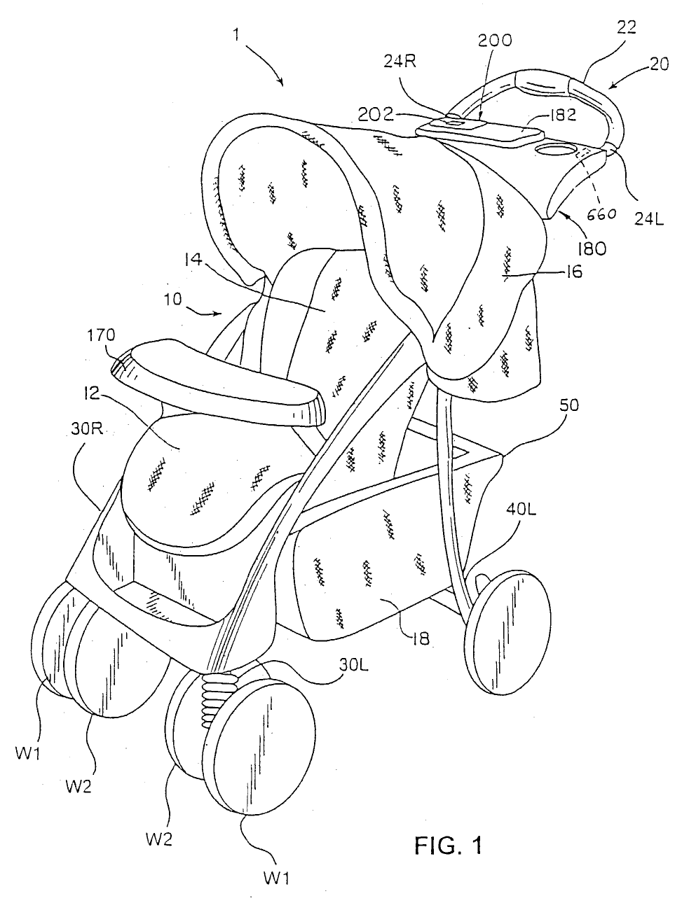

FIG. 1 shows a perspective view of a collapsible stroller 1 that can be used to transport a passenger. The stroller is shown with the associated “soft goods,” such as the seat 12, the back support 14, the canopy 16, the basket 18, etc., which are typically made of cloth or plastic or both, or a flexible material, to more clearly illustrate the stroller frame. The stroller 1 is generally intended for transporting children, but the inventive principles can be applied to all types of wheeled transports, including carts, wheelchairs, wagons, etc.

The stroller 1 includes a stroller frame 10 that is convertible between an operating or use position, and a collapsed or stowed position. The stroller frame 10 typically includes a handle frame 20, legs 30R, 30L, 40R (not shown), 40L, and a passenger support or frame 50.

The handle frame 20 comprises a gripping portion 22 and right and left push bars or arms 24R, 24L extending from the gripping portion 22. The gripping portion 22 and the right and left arms 24R, 24L form a generally U-shaped frame. The gripping portion 22 includes a right area for receiving a right hand of a user (not shown) and a left area for receiving a left hand of the user (not shown). The right and left areas can extend at an angle of less than one hundred eighty degrees with respect to each other, as is known in the art, to provide the gripping portion 22 with an ergonomically correct design, which enables the user to push the stroller 10 more comfortably.

Also, as shown in FIGS. 1-3, a parent tray 180 is attached to the handle arms 24L, 24R of the collapsible stroller of FIG. 1. The parent tray 180 can include a cup holder 183, a cellular phone holder (not shown) or the like.

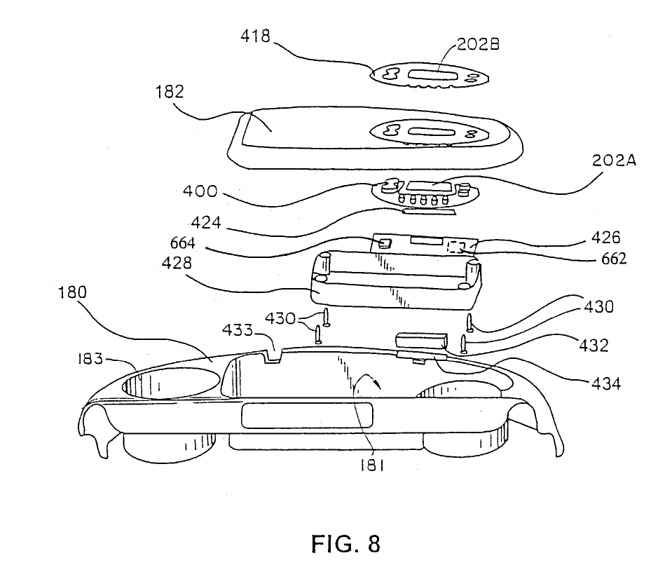

In one embodiment of the invention, a programmable information unit 200 is mounted to the parent tray 180. The programmable information unit 200 can include a display unit, such as modular electronic liquid crystal display (LCD) module 202, and a programmable information module. The programmable information module is configured to provide at least one user-programmable function and is coupled to the LCD module 202 so that the LCD module 202 can display information related to the programmable function selected by the user. Programmable modules are known in the art and any suitable programmable module can be utilized in the present invention. For example, the programmable information module can comprise discrete components, a microprocessor or other processor, an application specific integrated circuit (ASIC), or any other suitable electronic component, or any combination thereof, on a printed circuit board (PCB, such as PCB 426 in FIG. 8), or on any other substrate, to perform various computations. The operation and structure of the programmable information unit 200 will be discussed in further detail below.

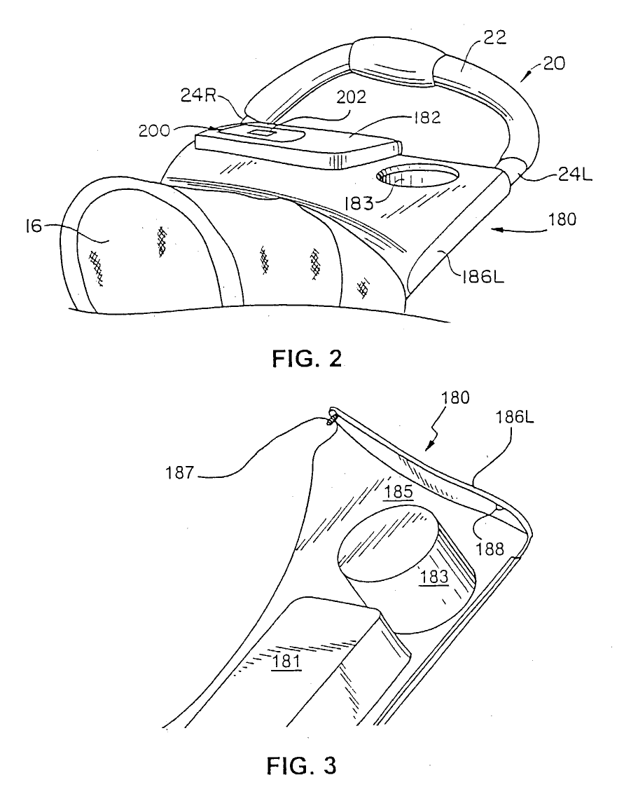

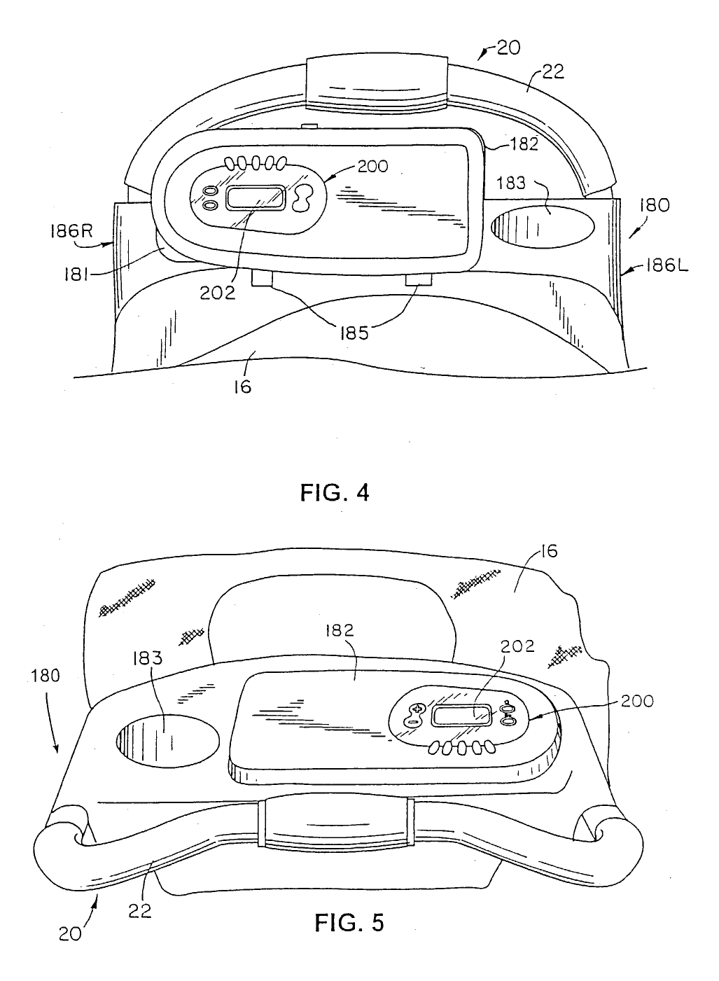

The parent tray 180 can have a removable and/or open and closable lid 182, as more clearly shown in FIGS. 2, 4 and 5. The lid 182 can be injection-molded to snap fit onto the parent tray 180. FIG. 2 is a close-up view of the parent tray 180 of the collapsible stroller of FIG. 1. As shown in FIG. 2, the lid 182 can support the programmable information unit 200, including the LCD module 202. FIG. 4 shows the lid 182 pivoted to an open position. The programmable information unit 200 pivots with the lid 182, exposing a storage area 181 beneath the lid 182. FIG. 5 shows a view of the lid of the parent tray 180 in a closed position. In this respect, the lid 182 can include a latch (not shown) cooperating with a complementary recess formed in the parent tray 180 to maintain the lid 182 in the closed position. As shown in FIG. 3, the parent tray 180 further can have at least one cup or container-holding recess 183.

The parent tray 180 is adapted to be removably connected to the stroller handle frame 20. FIG. 3 illustrates a partial bottom view of the parent tray 180 and shows one embodiment of mounting connectors 187, 188 to mount the parent tray 180 to the handle frame 20. The parent tray 180 has opposing side skirts 186 (186R, 186L) that respectively slip over the right and left handle arms 24R, 24L. The underside walls adjacent the side skirts 186R, 186L can be contoured complementary to the curvature of the right and left handle arms 24R, 24L so that the underside walls can sit on the top of the handle arms 24R, 24L. Each side skirt 186R, 186L has first and second mounting connectors or protrusions 187, 188, each adapted to project into a hole or recess in the respective handle arm 24R, 24L. In one embodiment, the first protrusion 187 can be a pin or the like, and the second protrusion 188 can be a bump or the like. The second protrusion 188 can engage a complementary dimple or indent formed in the respective handle arm 24R, 24L, or it can plainly engage the side of or slightly below the widest portion of the respective handle arm 24R, 24L so that the parent tray 180 is frictionally engaged to the handle arms 24R, 24L. The first protrusion 187 is sufficiently deep to lock the parent tray 180 to the respective arm 24R, 24L.

To attach the parent tray 180 to the handle frame 20, one of the first projections 187 is inserted into a complementary hole on one handle arm 24R, 24L, and the other of the first projections 187 is inserted into a complementary hole on the other handle arm 24L, 24R. The parent tray is pivotal about the first projections 187. After insertion of the first projections 187, the upper end of the tray 180 can be pivoted down so that the underside walls sit on the top of the handle arms 24R, 24L. The second projections 188 can engage complementary recesses in the handle arms 24R, 24L to retain the tray 180 in place.

To remove the parent tray 180, the upper end of the tray 180 is lifted away from the handle arms 24R, 24L so that the second projections 188 slip out of the recesses formed in the handle arms 24R, 24L. The first projections 187 then can be pulled out one at a time by pulling the respective side skirt 186R, 186L outwardly.

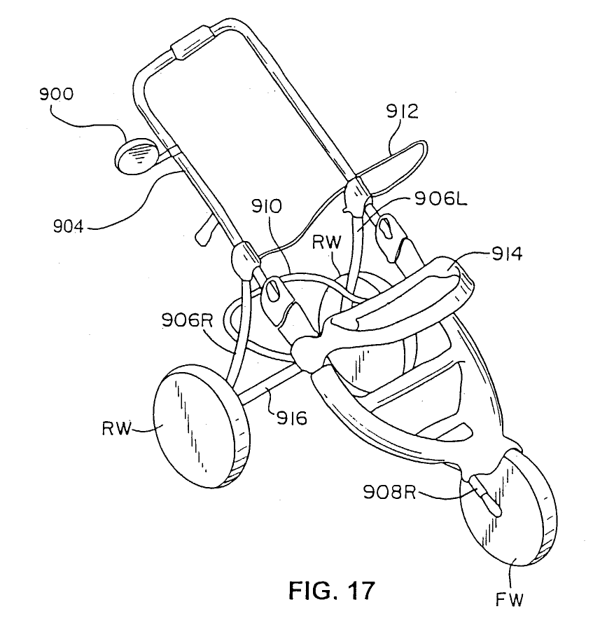

Although FIGS. 1-5 show the programmable information unit 200 located on the parent tray 180, it will be understood that, in other embodiments, the programmable information unit 200 can be located in the child's tray 170, which is removably connected to the front right and left legs, or it can be clipped or otherwise attached directly to a handle frame of the stroller, as seen, for example, in FIGS. 16 and 17.

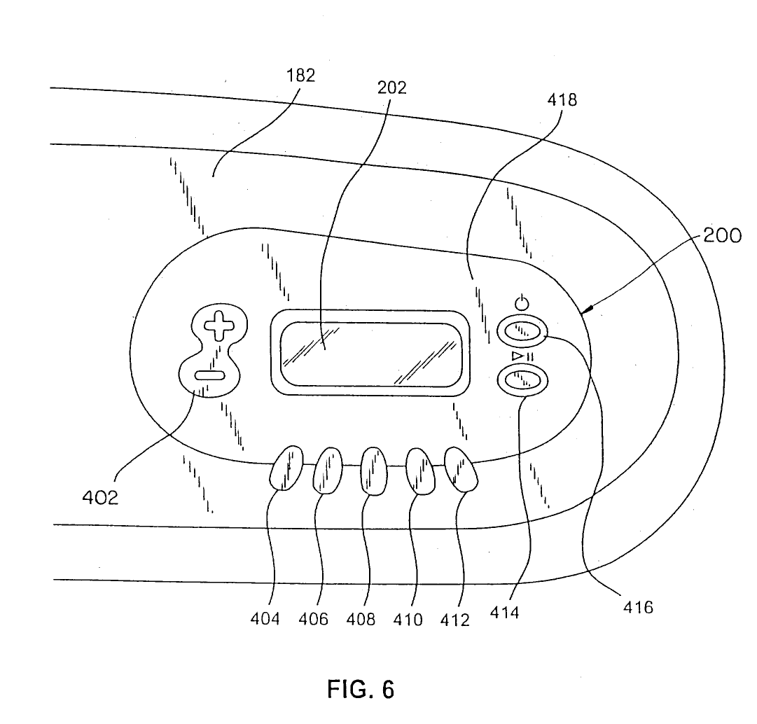

FIG. 6 is a top plan view of the programmable information unit 200 of FIG. 1. The unit 200 includes a liquid crystal display (LCD) module 202 and a programmable information module, which can be designed to reject stray high frequency input. In this embodiment of the programmable information unit 200, a bezel lens 418 provides a cover of the unit 200. The bezel lens 418 can be injection molded and can be made of any clear, durable plastic, such as clear PC or acrylic.

The programmable information unit 200 also can include an input device for receiving inputs from a user. The input device communicates with the programmable information unit to enable the user to select a function and program the function to be performed by the programmable information module. The input device can comprise a button key pad, for example, pad 400 in FIG. 8, that has individual buttons 402, 404, 406, 408, 410, 412, 414, 416 to allow user input. It will be understood that the input device can comprise a plurality switches, toggles, or other user-actuatable members as an alternative to buttons. Each button 402, 404, 406, 408, 410, 412, 414, 416 is associated with a user-programmable function that can be performed by the programmable information module. For example, button 402 can be used to program a timer and/or calorie counter. Buttons 404, 406, 408, 410, 412 can be used to select functions such as speed, timer, calories, distance, and temperature determination. Two more buttons 416, 414 may be situated, for example, to the right of the LCD module 202, for powering the programmable information module and for timer starting and stopping. When depressed, the buttons 402, 404, 406, 408, 410, 412, 414, and 416 actuate the programmable information module on the PCB 426 shown in FIG. 8. In the embodiment of FIG. 8, the programmable information module can comprise circuitry, discrete components, and/or a microprocessor or other processing unit on the PCB 426.

In one embodiment, the buttons can function as described below. The power button 416 turns the programmable information module on the PCB 426 on and off. The power button 416 may be recessed to prevent accidental power-up. The programmable information module on the PCB 426 may be set for activating a sleep mode after a predetermined period of time. When the programmable information module on the PCB 426 is turned on or awakened from a sleep mode, the time will display on the LCD 202 and the module will go into scroll mode, scrolling through the functions such as time, timer, calorimeter, distance, temperature and odometer, in turn, for a predetermined period of time for each function. Typically, the predetermined time is five seconds. The odometer only appears in the scroll mode and has no pointer displayed on the LCD 202.

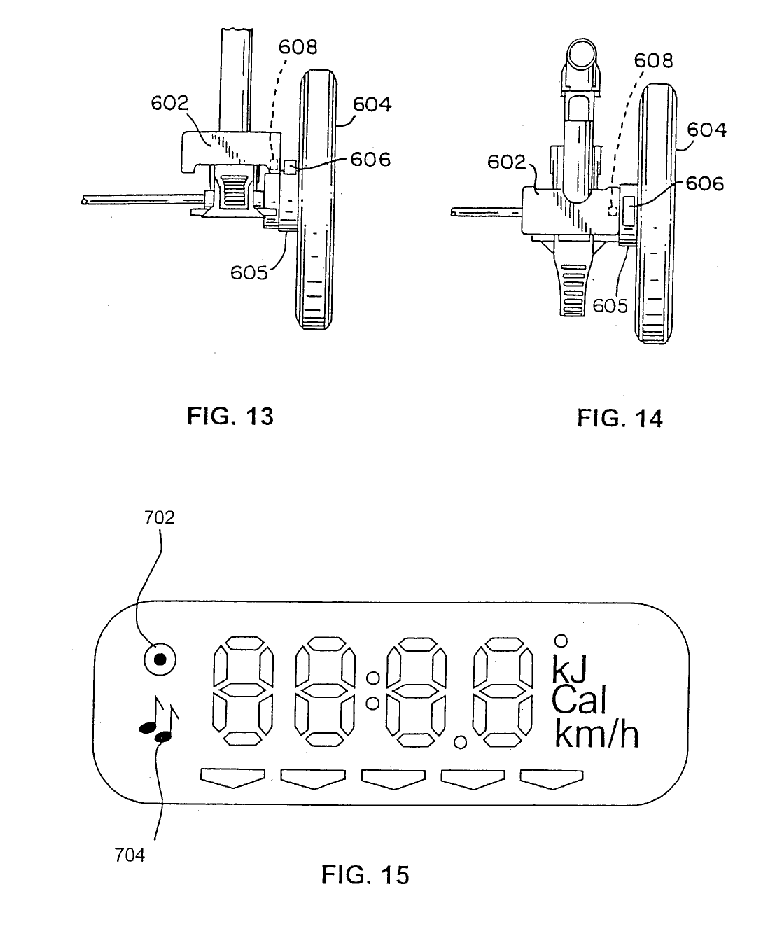

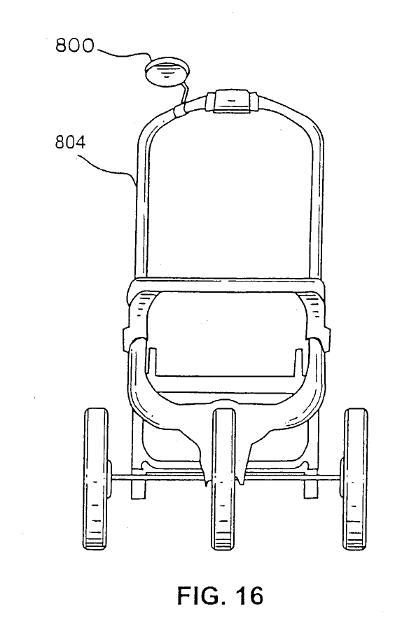

As shown in FIG. 15, a target ring 702 may be shown on the LCD 202, for example to the left of the other digital information. In one embodiment, when a signal is received from a transmitter module 602, shown in FIGS. 13 and 14 and described below, the targets go through the following repeated display sequence: target center alone, target ring alone, both. When no signal is received for 10 seconds, the target is not displayed. It should be noted that typically, when a countdown mode (time or distance) starts to run, musical notes 704 may be displayed. In this embodiment, when the countdown is paused, the musical notes 704 blink. When the countdown is completed, the musical notes 704 are displayed continuously until a beeper (not shown) finishes sounding, indicating the end of the countdown. Then, the musical notes 704 stop being displayed. The beeper operates as an annunciator to announce to the user that a zero value (time or distance) has been reached. The annunciator can comprise a visual, audio, or tactile element in electrical communication with the programmable information module and actuatable by the programmable information module when a zero value has been reached.

Turning back to FIG. 6, the Start/Stop button 414 starts and stops counter operation. If the Start/Stop button 414 is pushed and held for a predetermined period of time, for example, for more than five seconds, during timer, calorimeter, or distance modes, a reset to default values for the timer, the calorimeter and distance occurs.

The “+”/“−” button 402 is used for programming, as described more particularly herein.

When the Start/Stop time button 414 (also called the time button) is depressed, time, as well as all other functions, is displayed until another function is depressed. If the Start/Stop button 414 is held for a predetermined period of time, for example, for more than five seconds, the time flashes, and the module starts the time program mode. After time is programmed and set, the module returns to the clock function.

The timer button 406 can count up or down. When the timer button 406 is depressed, the programmable information module enters into the timer mode. A count up timer starts when the Start/Stop button 414 is depressed once and pauses when depressed again. When “+” or “−” is pressed during this function, the timer is stopped, changed into a countdown timer, and time is incremented by, for example, one minute, either up or down, depending on whether “+” or “−” is pressed. The “+” or “−” can be repeatedly depressed until the desired count down time is reached. Holding the “+” or “−” down has the same result as programming by repeatedly depressing the “+” or “−” ; that is, when the “+” or “−” is held down, the time continuously scrolls at one-minute increments at two minutes per second until the or “−” is released. The Start/Stop button 414 operates the count down timer in the same manner as with the count up timer. When “:00” is displayed, a beeper or other annunciator announces to the user that a zero value has been reached. Only one timer mode, either count up or countdown, operates at a time. The other timer mode is disabled until reset or the first timer mode is completed.

The calorimeter button 408 measures the average amount of energy burned given the person's body weight and distance traveled. If the calorimeter button 408 is held for a predetermined period of time, for example, for more than five seconds, the programmable information module starts weight program mode. After the weight is programmed and set, the module returns to the calorimeter function.

When the distance button 410 is depressed, the programmable information module enters into the distance function. If the distance button 410 is held down for a predetermined period of time, for example, for more than five seconds, the tire circumference flashes, and the module starts the tire circumference program mode. After the circumference is programmed and set, the module returns to the current distance function. The count up timer for distance starts when the Start/Stop button 414 is depressed once, and pauses when the button 414 is depressed again. When “+” or “−” is pressed during the distance count up mode, the timer is stopped, changed into distance countdown, and the distance is incremented by, for example, 0.1 units. If “+” or “−” button 402 is held down for a predetermined period of time, for example, for five seconds, the distance is incremented by, for example, 0.2 units per second. Counting down works in a similar fashion to counting up. When “0.0” is displayed, a beeper or other annuniciator announces to the user that a zero value has been reached. Only one distance mode, either count up or countdown, operates at a time. The other distance mode is disabled until reset, or the first distance mode is completed. In addition, the distance modes and the timer modes do not operate at the same time.

When the temperature button 412 is depressed, the ambient temperature is displayed. To monitor temperature, the programmable information unit 200 can include at least one temperature sensor, such as a thermocouple or a solid state PN junction temperature sensor. The output from the temperature sensor can be applied to an A/D converter on PCB 426, and the digital output can be input to the programmable information module for display on LCD module 202.

A suitable temperature sensing circuit can include a thermistor, which has a resistance that varies with temperature, and a single slope A/D converter. Most thermistors decrease in resistance with increasing temperature. A capacitor can be charged through a thermistor until a certain percentage of the supply voltage is reached, which would be detected by a voltage comparator. The time required to charge the capacitor to the threshold voltage varies with the resistance of the thermistor and therefore is indicative of temperature. The sensing and processing functions of this temperature detection function can be performed by the programmable information module. For example, one program to detect temperature involves: discharging a capacitor; resetting a the timer to zero (0); opening a discharge switch and starting the timer; waiting for the voltage threshold to be reached and detected by a comparator; reading the time from the timer; and converting the time to temperature, either with an equation or lookup table. In this manner, the programmable information module can determine an approximate ambient temperature.

In an alternative embodiment, the stroller includes an electronic temperature sensor mounted to the frame to detect an ambient temperature and a display unit that electrically communicates with the temperature sensor and displays the ambient temperature on a display unit. In this embodiment, sensing temperature does not involve programming the programmable information module.

In another aspect of the invention, the programmable information module located on the PCB 426 can include an auto-off/sleep function that is activated after 30 minutes of inactivity. Similarly, the timer and trip meter can be programmed to require resetting after, for example, four hours of inactivity.

Optionally, a supply capacitor can be utilized to maintain memory during battery changes. Also, a electroluminescent (EL) backlight or light emitting diode (LED) can be activated for a predetermined period of time, for example, five seconds, whenever a button is pushed. In addition, a beeper can be activated at the end of a countdown sequence for a timer or for distance or the like, as mentioned above, and a “click” sound can be emitted when a button is pushed.

In a preferred embodiment, the first time the electronic module is powered up or when a reset switch (not shown, but typically located on a back cover) is actuated, an initial programming sequence begins. At this time, the desired units for distance measurement may be set. For example, the units “km” and “m” may flash alternately until the “+” or “−” switch 402 is pressed—once for metric units or twice for English units. When the desired units are displayed, the Start/Stop button 414 is pressed.

Where motion-sensing functions are included in the programmable information module, the wheel circumference is requested. The wheel circumference is incremented by using the “+” or “−” button 402. When the “+” or “−” button is held for a predetermined period of time, for example, for more than two seconds, the switch will continue to increment or decrement at, for example, 2 units per second until the switch is released. To begin setting body weight, the Start/Stop button 414 is pressed. The body weight will flash, usually starting at 150 lb. in English units or 70 kg for metric units. Programming and setting are done in the same manner that the wheel circumference was entered.

Next, “12:00” flashes until programming begins or the Start/Stop button 414 is pressed. To program the current time and set a time, the same steps are followed as for setting the wheel circumference. When the programming is complete, time should be displayed.

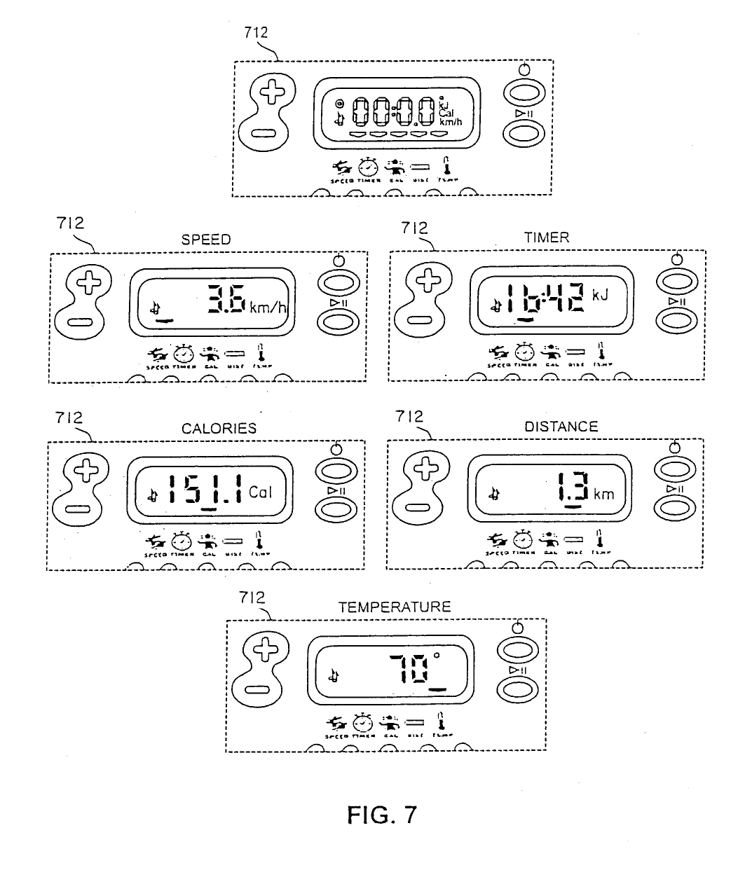

FIG. 7 shows a more detailed perspective view of the modular liquid crystal display of FIG. 1, here labeled 712, wherein five selected embodiments of the LCD module are represented. An overhead view of the LCD module 712 illustrates possible button controls for the programmable information unit 200. The programmable information unit 200 operates as an activity monitor, and LCD module 712 can display activity parameters, such as speed, time, calories burnt, distance, and temperature.

To measure and display calories burned, for example, the programmable information unit 200 can operate as follows. When a user powers on the programmable information unit 200 by depressing button 416, distance is reset to zero (0). Then, a counter(s) on the PCB 426 starts to accumulate the number of times a sensor associated with a wheel of the stroller, such as reed switch 608 shown in FIGS. 13-14 and described in more detail below, triggers. The sensor triggers in response to rotation of the wheel. The distance corresponds to the number of reed switch triggers plus one (1) (i.e., the number of times the wheel rotates) multiplied by the wheel circumference. The first time the sensor is triggered, a timer for determining speed starts, and, for each successive trigger of the sensor, the time between triggers is determined. Each time a sensor trigger occurs, the distance is incremented by the wheel circumference, and the calories are recalculated by the programmable information module using a known formula (calories=metabolic equivalent (MET)×distance×user's weight). When the calorimeter button 408 is pushed, or when the function scroll is at calorimeter, the value stored as calculated calories is displayed on LCD module 202. In this manner, the programmable information module can compute calories burned by a person pushing the stroller.

For speed, the programmable information module can divide the wheel circumference by the time between two sensor triggers, which represents one rotation of the wheel. When the speed button 404 is pushed, or when the function scroll is at speed, the speed is displayed on LCD module 202. In this manner, the programmable information module can alert the user to the speed of the stroller.

Another feature of the present invention involves monitoring a user's heart rate while he or she pushes the stroller. In this regard, the user can wear a heart rate monitor that generates an electronic signal(s) corresponding to each heart beat. The heart rate monitor electrically communicates with the programmable information module, so that the programmable information module receives the electronic signal(s) generated and transmitted by the monitor. The programmable information unit includes a port 720, as shown in FIG. 19, into which the heart rate monitor can be plugged to transmit signals to the programmable information module of unit 200. The programmable information module then can measure the time from heartbeat to heartbeat and can calculate the heart rate using computing techniques known in the art, and the programmable information unit 200 can display the user's heart rate on the LCD module 202. The heart rate monitor can be provided, for example, by an electrocardiograph sensor and transmitter held by a plastic band around the user's chest.

FIG. 8 is an exploded view of one embodiment of a parent tray assembly in accordance with the present invention. The programmable information unit 200 of this embodiment can include bezel lens 418, LCD module 202 (including LCD 202A and LCD cover 202B), input keypad 400, contact strip 424, and PCB 426. The bezel lens 418 fits into a depressed area of the injection-molded lid 182. The LCD cover 202B, which is substantially flush with the bezel lens 418, preferably is made of glass or plastic. The cover 202B can be an integral part of the bezel lens 418, or it can be a separate component. Keypad 400 includes function buttons 402, 404, 406, 408, 410, 412, 414, 416 that extend through the lid 182 to a position slightly below, flush with, or extended above the bezel lens 418, at a position where they can be actuated by a user. A contact strip 424 is sandwiched between the LCD 202A and a PCB 426 and electrically connects the LCD 202A to the PCB 426. The PCB 426 can include discrete components, a microprocessor, an ASIC, or any other suitable electronic element, or any combination thereof, to compute the user-selected functions. In this regard, the programmable information module can be provided by the discrete components, the microprocessor, the ASIC, or the other suitable electronic elements, or any combination thereof, mounted on the PCB 426. In other embodiments, the PCB 426 can be replaced by a substrate, and a microprocessor, an ASIC, or other suitable electronic element, or any combination thereof, can be mounted to the substrate to serve as the programmable information module. Further, the programmable information module can be provided by other alternative electronic arrangements configured to provide at least one user-programmable function. Typically, the PCB 426 is attached to a back cover 428 for support. The back cover 428, which interlocks with the lid 182, can have bosses sufficient to stabilize the PCB 426 and to keep it from flexing when the function buttons are depressed. Screws 430 can be used to couple the back cover 428 to the PCB 426 to ensure that the contact strip 424 has contact with the PCB 426 and the LCD 202A. The back cover 426 also can include a battery compartment that may hold, for example, two to three AA batteries. A battery door 434 can snap onto or be screwed the back cover 426, and a sponge 432 can be provided to absorb any liquid that may escape from the batteries. The sponge 432 can be glued to the battery door 434. The lid assembly can snap fit via connectors 185 (shown in FIG. 4) to attachment locations 433 (shown in FIG. 8) on the parent tray 180.

An EL backlight or LED can be used to provide illumination for the LCD 202A. Buttons 402, 404, 406, 408, 410, 412, 414, 416 typically are made of silicon rubber and can have diaphragms and a moisture resistant return lip. Conductive rubber contacts (not shown) are bonded to the underside of each button to provide for conductivity with the PCB 426 upon being depressed. The contact surfaces can be corrosion resistant.

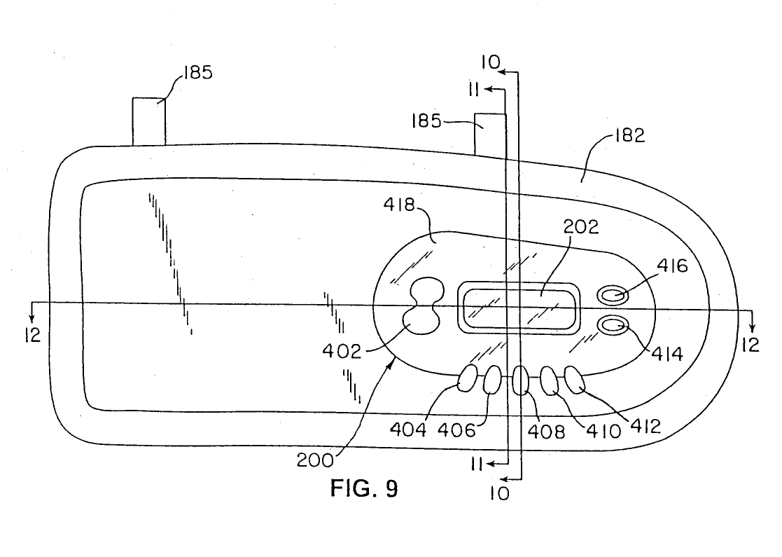

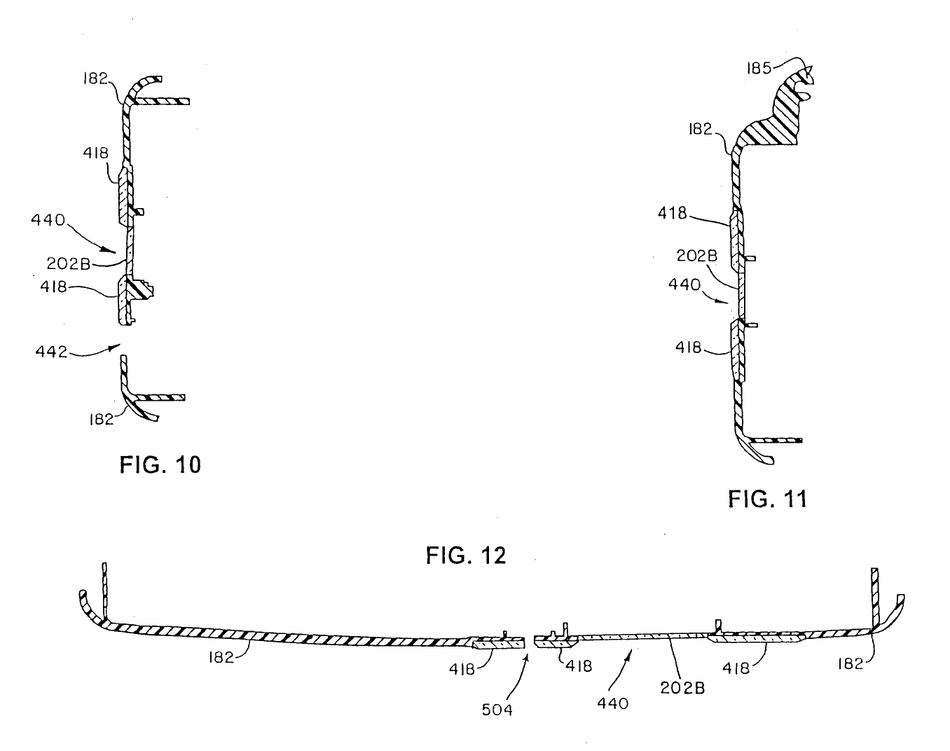

FIG. 9 is a schematic representation of top view of the programmable information unit 200. A front-to-back cross-section taken along line 10-10 of FIG. 9 cuts across the lid 182 as shown in FIG. 10, cutting through an operational function button (not shown), the bezel lens 418 and the LCD cover 202B, illustrating one embodiment of the apertures 440, 442 for placement of the LCD module 202 and the function button, respectively, as well as one embodiment of the placement of the LCD module 202 on the lid 182 of the parent tray 180.

A front-to-back cross-section taken along line 11-11 of FIG. 9, as shown in FIG. 11, cuts across the lid 182, cutting through the bezel lens 418, the LCD cover 202B, and the connector 185, illustrating one embodiment of the aperture 440 for the LCD module 202 and placement of the LCD module 202 on the lid 182 of the parent tray 180. A side-to-side cross-section taken along line 12-12 of FIG. 9, as shown in FIG. 12, cuts through the lid 182, the bezel lens 418, and the LCD cover 202B, illustrating one embodiment of the apertures 440, 504 for the LCD module 202 and the programming button 402 of the programmable information unit 200.

The parent tray 180 can have a receiver module coupled to the programmable information module and arranged to receive an electronic signal from a transmitter module associated with at least one wheel of the stroller. FIG. 1 shows one possible location for a receiver module 660 on the parent tray 180, and FIGS. 13 and 14 show a transmitter module 602 associated with a stroller wheel 604. FIG. 8 shows another possible location of the receiver module, where a section 662 of the PCB 426 is designated for receiver components, including an antenna, and the section 662 is electrically coupled to a microprocessor 664 performing as the programmable information module. The programmable information module can be programmed by a user to utilize the transmitted electronic signal to determine motion sensing functions, some of which may be the distance traveled or the speed of the stroller. The transmitter module 602 can house a transmitter PCB, an antenna, a reed switch (schematically represented by 608), and other transmitter components. A magnet 606 is embedded or press fit in the wheel 604, wheel hub, or other wheel structure, such as cog extender 605, of the stroller to close or activate the reed switch 608. The reed switch 608 can change between an ON state and an OFF state, depending on the position of the magnet 606. For example, the reed switch 608 initially can be spaced from the magnet 606, and, as the wheel rotates and the magnet 606 moves within close proximity to the reed switch 608, the transmitter module 602 monitoring the reed switch 608 detects a change in the reed switch 608 from OFF to ON and sends an electronic signal to a receiver, for example receiver section 662 as shown in FIG. 8. A one-shot circuit is incorporated in the transmitter module 602 so that the transmitter module 602 sends a single pulse when the reed switch 608 changes state, regardless of how long the switch 608 stays in close proximity to the magnet 606. Because signal transmission in this stroller embodiment is wireless, the stroller can collapsed with minimal impact on the integrity and durability of the signal transmission components.

The transmitter module preferably has a transmission strength powerful enough to transmit signals past the stroller frame to the receiver module without signal interference by the stroller frame. For example, the transmitter module can transmit signals to about a 1.5 m range. Likewise, the receiver module preferably is sensitive enough to pick up signal transmissions from the transmitter module without signal interference by the stroller frame. For example, the receiver module can pick up signals to about a 1.5 m range. In addition, the transmission antenna and receiver antenna preferably are located in the transmitter module and the receiver module, respectively, to minimize disruption of signal transmission. In this regard, the transmitter antenna and the receiver antenna preferably are in line of sight with one another, that is, unobstructed by the tubing of the stroller frame or by other radio-interfering stroller elements. For example, referring to FIGS. 1 and 13, the signal can be transmitted from a position near the right rear wheel 604 to the left side of the parent tray 180, on the rear side of the stroller.

Generally, the transmitter module 602 is powered by at least one battery, which may be located in the module 602 for convenience. Also, the receiver circuit is typically arranged be to shut off by the programmable information unit 202 when not in use.

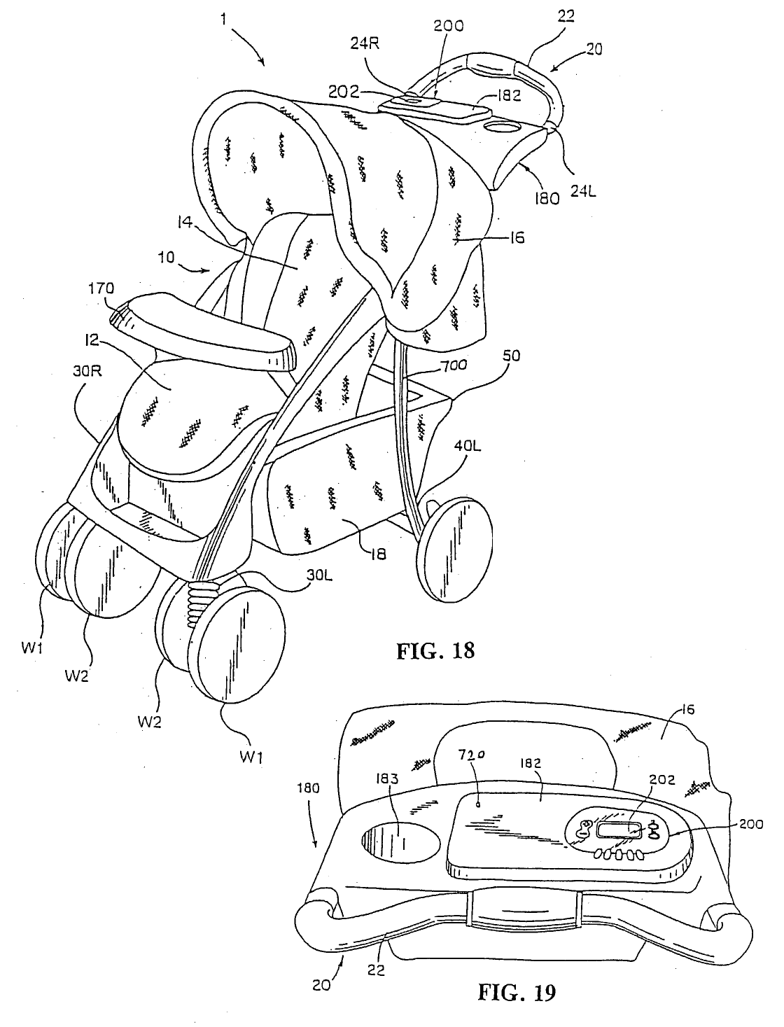

The embodiment shown in FIGS. 13 and 14 employs wireless transmission to transmit an electrical signal from a transmitter module 602 to a receiver module 660. In an alternative embodiment, the stroller is hard-wired. FIG. 18 illustrates an embodiment of a hard-wired stroller. In the hard-wired alternative, the stroller includes a sensor, such as reed switch 608 shown in FIGS. 13 and 14, associated with at least one wheel of the stroller. The stroller also includes a signal propagation element 700, such as a wire, that connects the reed switch 608 directly to an input of the programmable information unit 200. For example, where the programmable information module is provided by a microprocessor, wire 700 can connect directly to the I/O port of the microprocessor. The reed switch 608 switches between an ON and OFF state, dependent on the location of magnet 606, and generates a signal (ON or OFF) that is transmitted to the unit 200 via the wire 700. The wire 700 extends from a position adjacent the wheel along the respective leg (in FIG. 18, 40L), along the respective arm (in FIG. 18, 24L), into the parent tray 180, and then to the programmable information unit 200. The signal can represent a single wheel rotation, or the number of wheel rotations over a period of time, and can be used to calculate distance traveled, speed, and other desired parameters. This hard-wired stroller offers an inexpensive alternative to the wireless stroller embodiment described above.

As mentioned above, the programmable information unit 200 includes a programmable information module that provides at least one user-programmable function. In this regard, the programmable information module can be programmed, for example, to compute distance traveled, to compute calories burned by a person pushing the stroller, to compute time elapsed during a period of time that the stroller is pushed, to be preset by a user to a desired value of either time or distance and then be programmable by the user to start with the desired time or desired distance and count down to a zero value, to compute a speed at which the stroller is traveling, or to determine an approximate ambient temperature, each for display on a display unit.

The following description describes one embodiment of a collapsible stroller, as is known in the art, in which the present programmable information unit 200 can be employed; however, it will be recognized that the programmable information unit 200 can be used on any stroller frame or any wheeled transports, including carts, wheelchairs, wagons, etc.

Referring to FIG. 1, the stroller has a front right (FR) leg 30R, a front left (FL) leg 30L, a rear right (RR) leg 40R, and a rear left (RL) leg 40L. Each leg 30R, 30L, 40R, 40L has a lower end to which at least one rotatable wheel W is mounted. The front legs 30 each can have a pair of rotatable wheels W1, W2. The rear legs 40R, 40L may be reinforced with a cross brace (not shown). The front and rear legs 30R, 30L, 40R, 40L are pivotally mounted to the handle frame 20 so that the stroller frame can be folded between the collapsed and operating positions. For example, a first pair of hinges (not shown) can connect the handle frame 20 to the front legs 30R, 30L, and a second pair of hinges (not shown) can connect the handle frame 20 to the rear legs 40R. 40L. The stroller also can include fold lock mechanisms to fold the frame between the collapsed and operating positions. Suitable fold lock mechanisms include those disclosed in co-pending U.S. patent application Ser. No. 09/178,461, filed Oct. 23, 1998, in U.S. Pat. No. 5,454,584, and in U.S. Pat. No. 5,605,409, the disclosures of which are incorporated herein by reference. Alternatively, the stroller also can include a one hand fold mechanism as described in U.S. Pat. No. 6,068,284, the disclosure of which is incorporated herein by reference.

The stroller also can include a canopy 16 pivotally mounted to the handle arms 24R, 24L to permit the canopy 16 to be moved between a position where it extends outwardly from the handle arms 24R, 24L to shade the passenger and a position where it is pulled against handle arms 24R, 24L.

As described in aforementioned U.S. Pat. Nos. 5,454,584 and 5,605,409, the disclosures of which are incorporated herein by reference, the passenger support 50 can include a substantially U-shaped seat support frame. A storage basket 18 or the like can hang from the seat support frame to provide a storage area. The seat support frame can be pivotally mounted to the respective front and rear legs 30R, 40R, 30L, 40L.

The stroller also can include a substantially U-shaped back support frame (not visible). The back support frame can be pivotally mounted to the seat support frame and can have an automatic reclining latch (not shown), as is known in the art. The automatic reclining latch allows the back support frame to move automatically from the upright position to the recumbent position, when the stroller is being collapsed, as disclosed in the aforementioned patents.

Where desired, the stroller frame 10 further can include a latch (not shown) that releasably and automatically locks the frame 10 in the collapsed position, such as that disclosed in U.S. Pat. No. 5,605,409, the disclosure of which is incorporated herein by reference.

Further, the stroller 1 can include a child tray 170 for the convenience of the child and/or a footrest. The child tray 170, the parent tray 180, and the footrest assembly all can be made of plastics, such as polypropylene, nylon, etc.

The stroller 1 also can include a stand (not shown) that enables the stroller to maintain the upright position. This way, the stroller can be more easily manipulated, as the user does not need to bend down to retrieve the stroller 1 when folded.

FIG. 16 is a schematic representation of a jogging stroller frame that employs a programmable information unit 800 in accordance with the present invention. FIG. 16 does not show the soft goods of the jogging stroller. In this embodiment, the programmable information unit 800 is clamped to a gripping portion 804 of a push handle of the jogging stroller.

FIG. 17 is a schematic representation that shows an alternative mounting arrangement of a programmable information unit on a jogging stroller frame in accordance with the present invention. In this embodiment, the programmable information unit 900 is clamped to an arm portion of a push handle 904. As can be seen in FIG. 17, the jogging stroller frame generally can include rear legs 906R, 906L, that each terminate at a rear wheel RW; front legs 908R, 908L (not shown, obscured by front molding) that converge at a front wheel FW; a child seat frame 910; a canopy frame 912; a child tray 914; a rear cross brace 916; and a front cross brace (not shown, obscured by front molding). The jogging stroller of FIG. 16 can include these same general frame elements.

It will be understood that that the a parent tray having a programmable information unit, such as parent tray 180 in FIG. 1, can be mounted to the handle of the jogging stroller frame of FIGS. 16 and 17 in the manner shown and described in connection with FIGS. 1-5. Likewise, it will be understood that the programmable information unit can be mounted directly to a portion of the handle frame 20 of stroller 1 of FIGS. 1-5 in the manner shown and described in connection with FIGS. 16 and 17.

Thus, according to the invention, an electronic programmable information unit is provided for attachment to a handle frame of a stroller. The unit can be mounted to a parent tray, which in turn is attached, generally removably, to the handle frame of the stroller. The programmable information unit is configured to receive input from a user and provides for selectably displaying information for an electronic function selected by the user, as described above.

The parent tray also can be described as having a display control apparatus with a data integrating, programmable information unit, where the parent tray is attached to the handle frame, and the programmable information unit is arranged to receive a signal from a wheel position recognition device of the stroller and is utilized for processing information to generate a digital output for a function selected by a user.

Also according to the invention, a stroller is provided that has a collapsible frame movable between a collapsed position and an operating position, the collapsible frame having a handle frame and front right, front left, rear right, and rear left legs pivotally connected to the handle frame, where a parent tray with a function-selectable programmable electronic module is attached to the handle frame and arranged to receive a signal from a transmitter located proximate to a wheel of the stroller. Various characteristics of the stroller may be as described above.

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention. The scope of the present invention accordingly is to be defined as set forth in the appended claims.

What is claimed is:

1. A stroller having a programmable information module, comprising:
a frame having a handle frame; and
a programmable information module attached to the handle frame and configured to provide at least one user-programmable function.

2. The stroller of claim 1, wherein the programmable information module is programmable by a user to compute distance traveled.

3. The stroller of claim 1, wherein the programmable information module is programmable by a user to compute calories burned by a person pushing the stroller.

4. The stroller of claim 1, wherein the programmable information module is programmable by a user to compute time elapsed during a period of time that the stroller is pushed.

5. The stroller of claim 1, wherein the programmable information module is preset by a user to a desired value of at least one of distance and time and then is programmable by the user to start with the desired value and count down to a zero value.

6. The stroller of claim 5, further comprising an annunciator electrically communicating with the programmable information module to announce to the user that the programmable information module has reached zero value.

7. The stroller of claim 1, wherein the programmable information module is programmable by a user to compute a speed at which the stroller is traveling.

8. The stroller of claim 1, wherein the stroller further includes a display unit, and the programmable information module is programmable by a user to determine an approximate ambient temperature and display the temperature on the display unit.

9. The stroller of claim 1, further comprising a transmitter module associated with at least one wheel of the stroller and a receiver module arranged to receive an electronic signal representative of wheel rotation from the transmitter module, wherein the programmable information module is coupled to the receiver module and is programmed by a user to utilize the electronic signal to determine at least a distance traveled by the stroller.

10. The stroller of claim 9, wherein the transmitter module includes a reed switch, the stroller includes a magnet located in a wheel unit of the stroller, and the transmitter module monitors changes in the reed switch dependent on the location of the magnet as the at least one wheel of the stroller rotates and sends the electronic signal representative of the change to the receiver module.

11. The stroller of claim 9, wherein the transmitter module is powered by at least one battery.

12. The stroller of claim 1, further comprising a sensor associated with at least one wheel of the stroller, a receiver module arranged to receive an electronic signal representative of wheel rotation from the sensor, and a signal propagation element to transmit the electronic signal from the sensor to the receiver module, wherein the programmable information module is coupled to the receiver module and is programmed by a user to utilize the electronic signal to determine at least a distance traveled by the stroller.

13. The stroller of claim 12, wherein the stroller includes a magnet located in a wheel unit of the stroller, the sensor comprises a reed switch that changes in response to changes in location of the magnet as the at least one wheel of the stroller rotates, and the reed switch sends the electronic signal representative of the change via the signal propagation element to the receiver module.

14. The stroller of claim 1, wherein the programmable information module is coupled to a receiver module arranged to receive an electronic signal representative of wheel rotation from a sensor associated with at least one wheel of the stroller, the programmable information module is programmed by a user to utilize the electronic signal to determine at least a distance traveled by the stroller, and the sensor detects rotation of the at least one wheel and electrically communicates with the receiver module to transmit the electronic signal to the receiver module.

15. The stroller of claim 1, wherein the programmable information module comprises at least one of a microprocessor, circuitry on a printed circuit board, and an application specific integrated circuit.

16. The stroller of claim 1, further comprising a programmable information unit including an input device for receiving input data from a user, the programmable information module for processing the input data, and a display device for displaying information generated by the programmable information module.

17. The stroller of claim 16, wherein the input device comprises input keys.

18. The stroller of claim 16, wherein the display device comprises a liquid crystal display.

19. The stroller of claim 1, wherein the programmable information module is connected directly to the handle frame.

20. The stroller of claim 1, wherein the programmable information module is mounted to a parent tray mounted to the handle frame.

21. The stroller according to claim 1, further including a child's tray removably connected to the front right and left legs.

22. The stroller of claim 1, wherein the stroller is a jogging stroller.

23. The stroller of claim 22, wherein the handle frame of the jogging stroller is coupled to two rear legs and that each terminate at a separate rear wheel, and wherein the handle frame is further coupled to two front legs that converge at one front wheel.

24. The stroller of claim 1, wherein the stroller frame further comprises:
front right, front left, rear right, and rear left legs pivotally connected to the handle frame, each of the legs connected to at least one wheel;
a seat frame pivotally connected to the front and rear right legs and to the front and rear left legs; and
a cross brace connected to the rear right and left legs,
wherein the stroller frame is movable between a collapsed position and an operating position.

25. A stroller comprising:
a handle frame; and
a programmable information module attached to the handle frame and configured to provide at least one user-programmable function, the user-programmable function computing calories burned by a person pushing the stroller.

26. A stroller comprising:
a handle frame; and
a programmable information module attached to the handle frame and configured to provide at least one user-programmable function, the user-programmable function determining an approximate ambient temperature; and
a display connected to the handle frame to display the ambient temperature on a display unit.

27. A stroller comprising
a handle frame;
a programmable information module attached to the handle frame and configured to provide at least one user-programmable function;
front right, front left, rear right, and rear left legs pivotally connected to the handle frame;
a seat frame having right and left arms pivotally connected to the front and rear right legs and the front and rear left legs, respectively; and
a cross brace connected to the rear right and left legs,
wherein the stroller is movable between a collapsed position and an operating position.

28. The stroller of claim 27, wherein the stroller further includes a parent tray mounted to the handle frame, and the programmable information module is mounted to the parent tray.

29. The stroller of claim 28, wherein the parent tray is removably mounted to the handle frame.

30. The stroller of claim 27, wherein the programmable information module is programmable to compute distance traveled.

31. The stroller of claim 27, wherein the programmable information module is programmable by a user to compute calories burned by a person pushing the stroller.

32. The stroller of claim 27, wherein the programmable information module is programmable by a user to compute time elapsed during a period of time that the stroller is pushed.

33. The stroller of claim 27, wherein the programmable information module is preset by a user to a desired value of at least one of distance and time and then is programmable by the user to start with the desired value and count down to a zero value.

34. The stroller of claim 33, further comprising an annunciator electrically communicating with the programmable information module to announce to the user that the programmable information module has reached zero value.

35. The stroller of claim 27, wherein the programmable information module is programmable by a user to compute a speed at which the stroller is traveling.

36. The stroller of claim 27, wherein the stroller further includes a display unit, and the programmable information module is programmable by a user to determine an approximate ambient temperature and display the ambient temperature on a display unit.

37. The stroller of claim 27, further comprising a transmitter module associated with at least one wheel of the stroller and a receiver module arranged to receive an electronic signal representative of wheel rotation from the transmitter module, wherein the programmable information module is coupled to the receiver module and is programmed by a user to utilize the electronic signal to determine at least a distance traveled by the stroller.

38. The stroller of claim 37, wherein the transmitter module includes a reed switch, the stroller includes a magnet located in a wheel unit of the stroller, and the transmitter module monitors changes in the reed switch dependent on the location of the magnet as the at least one wheel of the stroller rotates and sends the electronic signal representative of the change to the receiver module.

39. The stroller of claim 37, wherein the transmitter module is powered by at least one battery.

40. The stroller of claim 27, further comprising a sensor associated with at least one wheel of the stroller, a receiver module arranged to receive an electronic signal representative of wheel rotation from the sensor, and a signal propagation element to transmit the electronic signal from the sensor to the receiver module, wherein the programmable information module is coupled to the receiver module and is programmed by a user to utilize the electronic signal to determine at least a distance traveled by the stroller.

41. The stroller of claim 40, wherein the stroller includes a magnet located in a wheel unit of the stroller, the sensor comprises a reed switch that changes in response to changes in location of the magnet as the at least one wheel of the stroller rotates, and the reed switch sends the electronic signal representative of the change via the signal propagation element to the receiver module.

42. The stroller of claim 27, wherein the programmable information module is coupled to a receiver module arranged to receive an electronic signal representative of wheel rotation from a sensor associated with at least one wheel of the stroller, the programmable information module is programmed by a user to utilize the electronic signal to determine at least a distance traveled by the stroller, and the sensor detects rotation of the at least one wheel and electrically communicates with the transmitter module to transmit the electronic signal to the receiver module.

43. The stroller of claim 27, wherein the programmable information module comprises at least one of a microprocessor, circuitry on a printed circuit board, and an application specific integrated circuit.

44. The stroller of claim 27, further comprising a programmable information unit including an input device for receiving input data from a user, the programmable information module for processing the input data, and a display device for displaying information generated by the programmable information module.

45. The stroller of claim 44, wherein the input device comprises input buttons.

46. The stroller of claim 44, wherein the display device comprises a liquid crystal display.

47. A programmable information unit for a stroller, the programmable information unit comprising:
a device attached to the handle frame, having disposed therein:
a programmable information module coupled to receive input from a user; and
a display unit, coupled to the programmable information module, for selectably displaying information for an electronic function selected by the user.

48. The programmable information unit of claim 47, wherein the programmable information unit is removably attached to the handle frame.

49. The programmable information unit of claim 47, wherein the programmable information module is programmable to compute distance traveled.

50. The programmable information unit of claim 47, wherein the programmable information module is programmable by a user to compute calories burned by a person pushing the stroller.

51. The programmable information unit of claim 47, wherein the programmable information module is programmable by a user to compute time elapsed during a period of time that the stroller is pushed.

52. The programmable information unit of claim 47, wherein the programmable information module preset by a user to a desired value of at least one of distance and time and then is programmable by the user to start with the desired value and count down to a zero value.

53. The programmable information unit of claim 52, further comprising an annunciator electrically communicating with the programmable information module to announce to the user that the programmable information module has reached zero value.

54. The programmable information unit of claim 47, wherein the programmable information module is programmable by a user to compute a speed at which the stroller is traveling.

55. The programmable information unit of claim 47, wherein the programmable information module is programmable by a user to determine an approximate ambient temperature and display the ambient temperature on the display unit.

56. The programmable information unit of claim 47, wherein the programmable information unit is coupled to a receiver module that is arranged to receive an electronic signal representative of wheel rotation from a transmitter module associated with at least one wheel of the stroller, and the programmable information module is programmed by a user to utilize the electronic signal to determine at least a distance traveled by the stroller.

57. The programmable information unit of claim 47, wherein the programmable information unit is coupled to a receiver module that is arranged to receive an electronic signal representative of wheel rotation from a sensor associated with at least one wheel of the stroller, and the programmable information module is programmed by a user to utilize the electronic signal to determine at least a distance traveled by the stroller.

58. The programmable information unit of claim 47, wherein the programmable information module comprises at least one of a microprocessor, circuitry on a printed circuit board, and an application specific integrated circuit.

59. The programmable information unit of claim 47, further comprising an input device for receiving input data related to the electronic function selected by the user, wherein the programmable information module processes the input data.

60. The programmable information unit of claim 59, wherein the input device comprises input buttons.

61. The programmable information unit of claim 59, wherein the display device comprises a liquid crystal display.

62. A programmable information unit for a stroller, the programmable information unit comprising:
a device attached to the handle frame, having disposed therein:
a programmable information module coupled to receive input from a user,
the programmable information module programmable to compute calories burned by a person pushing the stroller based on the input from the user; and
a display unit, coupled to the programmable information module, for selectably displaying information representative of the calories burnt.

63. A programmable information unit for a stroller, the programmable information unit comprising:
a device attached to the handle frame, having disposed therein:
a programmable information module coupled to receive input from a user, the programmable information module programmable by the user to determine an approximate ambient temperature ; and
a display unit, coupled to the programmable information module, for selectably displaying the ambient temperature.

64. A stroller comprising:
a collapsible frame movable between a collapsed position and an operating position, the collapsible frame having a handle frame and front right, front left, rear right, and rear left legs pivotally connected to the handle frame; and
a parent tray attached to the handle frame, the parent tray having a programmable information module mounted thereto arranged to receive a signal from a transmitter located proximate to a wheel, wherein the signal represents rotation of the wheel.

65. The stroller of claim 64, wherein the parent tray is removably attached to the handle frame.

66. A stroller comprising:
a stroller frame having a handle frame and front right, front left, rear right, and rear left legs connected to the handle frame, each of the legs terminating at a wheel;
a parent tray attached to a handle frame;
a programmable information module mounted to the parent tray; and
a wheel position recognition device associated with at least one wheel of the stroller, the wheel position recognition device generating a signal representative of rotation of the wheel for transmission to and processing by the programmable information module.

67. The stroller of claim 66, wherein the parent tray is removably attached to the handle frame.

68. The stroller of claim 66, wherein the programmable information module includes an electronic module that is programmable to compute distance traveled.

69. The stroller of claim 66, wherein the programmable information module includes an electronic module that is programmable by a user to compute calories burned by a person pushing the stroller.

70. The stroller of claim 66, wherein the programmable information module includes an electronic module that is programmable by a user to compute time elapsed during a period of time that the stroller is pushed.

71. The stroller of claim 66, wherein the programmable information module includes an electronic module that is preset by a user to a desired value of at least one of distance and time and then is programmable by the user to start with the desired value and count down to a zero value.

72. The stroller of claim 71, further comprising an annunciator electrically communicating with the programmable information module to announce to the user that the programmable information module has reached zero value.

73. The stroller of claim 66, wherein the programmable information module includes an electronic module that is programmable by a user to compute a speed at which the stroller is traveling.

74. The stroller of claim 66, wherein the programmable information module includes an electronic module that is programmable by the user to determine an approximate ambient temperature.

75. The stroller of claim 66, further comprising a transmitter module associated with at least one wheel of the stroller and a receiver module arranged to receive an electronic signal representative of wheel rotation from the transmitter module, wherein the programmable information module is coupled to the receiver module and is programmed by a user to utilize the electronic signal to determine at least a distance traveled by the stroller.

76. The stroller of claim 75, wherein the transmitter module includes a reed switch, the stroller includes a magnet located in a wheel unit of the stroller, and the transmitter module monitors changes in the reed switch dependent on the location of the magnet as the at least one wheel of the stroller rotates and sends the electronic signal representative of the change to the receiver module.

77. The stroller of claim 66, wherein the programmable information module is coupled to a receiver module arranged to receive an electronic signal representative of wheel rotation from a sensor associated with at least one wheel of the stroller, the programmable information module is programmed by a user to utilize the electronic signal to determine at least a distance traveled by the stroller, and the sensor detects rotation of the at least one wheel and electrically communicates with the receiver module to transmit the electronic signal to the receiver module.

78. A stroller comprising:
a frame having a handle frame;
a programmable information unit attached to the handle frame, the programmable information unit having a programmable information module and a port to receive electronic signals from a heart rate monitor and to transmit the electronic signals to the programmable information module, the programmable information module being configured to calculate heart rate based on the electronic signals.

79. A stroller comprising:
a frame;
an electronic temperature sensor mounted to the frame to detect an ambient temperature; and
a display unit that electrically communicates with the temperature sensor and displays the ambient temperature on a display unit.

80. A stroller comprising:
a frame and wheels;
a sensing unit to detect rotation of at least one of the wheels and to generate and transmit signals, each representative of a rotation of the at least one wheel;
an electronic calorimeter configured to electrically communicate with the sensing unit, wherein the electronic calorimeter accumulates and processes the signals to compute calories burned by a person pushing the stroller.

81. The stroller of claim 80, wherein the sensing unit includes a switch that changes state in accordance with each rotation of the at least one wheel and a transmitter that generates and transmits a signal to the calorimeter each time the switch changes state.
